(19) United States
(12) Patent Application Publication
(10) Pub. No.: US 2012/0214626 A1
(43) Pub. Date: Aug. 23, 2012

(54) Adjustable flyweight for CVT clutch

(76) Inventor: Travis A. Cook, Prairie, ID (US)

(21) Appl. No.: 13/385,450

(22) Filed: Feb. 21, 2012

Related U.S. Application Data
(60) Provisional application No. 61/463,739, filed on Feb. 22, 2011.

(51) Int. Cl. F16H 61/662; F16D 43/06

(52) U.S. Cl. 474/14

(57) ABSTRACT

Disclosed is a modified CVT flyweight that allows for a 1 to 15 degree bidirectional change of pitch-angle of the cam section of a flyweight to variably affect the load placed on a connected drive-unit to match changes in elevation or terrain. Enabling the cam pitch-angle adjustment is a secondary pivotal axis (separate from the primary centrifugal axis) that is incrementally rotated and held in position by a manually rotated threaded fastener acting as a cantilever upon one side of the pivot. There may be removable weights in the form of threaded screws, pins or rivets that can be added or subtracted from the flyweight in addition to changes in the cam pitch-angle to affect the overall mass of the flyweight and also adjust the maximum RPM's of the engine.

This application claims priority of Provisional Application Ser. No. 61/463,739, filed Feb. 22, 2011 and entitled “Adjustable Flyweight for CVT Clutch”, which is herein incorporated by reference.

### BACKGROUND OF THE INVENTION

### Field of the Invention

The present invention relates to eccentric-action, arm-style or cam-action flyweights that are typically used in Continuously Variable Transmissions, or CVT's, as are employed by personal recreational vehicles such as snowmobiles and all-variety of surfaces such as snow, mud and dirt. Conventionally, CVT's are comprised of two interacting pairs of rotatable sheaves correspondingly connected by a common v-shaped drive belt. The pair of sheaves connected to the drive-engine is called the primary, or drive, clutch. The pair of sheaves connected to the drivetrain is called the secondary, or driven, clutch. The spacing of the sheaves in the primary drive clutch usually is controlled by centrifugal flyweights. Centrifugal flyweights are typically connected to the engine shaft so that they rotate along with the engine shaft. As the engine shaft rotates faster (in response to increased engine speed) the flyweights also rotate faster and pivot outwardly, forcing the movable sheave toward the stationary sheave. The more outwardly the flyweights pivot, the more the moveable sheave is moved toward the stationary sheave. This pinches the drive belt, the resulting friction causing the belt to begin rotating with the drive clutch, the belt in turn causing the driven clutch to begin to rotate. Further movement of the device clutch's movable sheave toward the stationary sheave forces the belt to climb outwardly on the drive clutch sheaves, increasing the effective diameter of the drive belt path around the drive clutch. Thus, the spacing of the sheaves in the drive clutch changes based on engine speed. The drive clutch therefore can be said to be continuously variable in nature.

As the sheaves of the drive clutch pinch the drive belt and force the belt to climb outwardly on the drive clutch sheaves, the belt is pulled inwardly between the sheaves of the driven clutch, decreasing the effective diameter of the drive belt path around the driven clutch. This movement of the belt outwardly and inwardly on the drive and driven clutches, respectively, changes the effective gear ratio of the transmission in variable increments.

Summarily, belt driven CVTs are mechanical devices in which certain specific tuning parameters are established when the CVT is assembled. Once assembled, the gear ratio of the CVT depends on these set parameters. During operation, the gear ratio being used is dependent upon the distance between the drive clutch sheaves. The distance between the drive clutch sheaves is determined by the amount of force produced by the flyweights against the movable sheave. As the flyweights are attached to the engine shaft, the amount of the flyweight force depends on the RPM of the engine shaft, and is therefore centrifugal in nature.

The maximum speed of the engine is thus also controlled by opposing load from the drivetrain induced by these flyweights.

### Related Art

Non-adjustable flyweights having a fixed profile and mass which are conventionally employed in CVT's are of a monolithic design. While most desirable for OEM applications due to the set nature of the design which inhibits tampering, performance is sacrificed at differing power levels other than that at for which the flyweight mass is specifically tuned. If an operator or tuner wishes to vary the output of the engine for their specific riding style, they are forced to remove the flyweights from the vehicle and either grind or cut away mass from the flyweights or purchase entirely new flyweights of a more suitable mass to obtain proper peak RPM, which is an obvious obstacle to be overcome. Also, the cam surface of these particular flyweights is designed with a non-adjustable and somewhat-passive cam profile specifically engineered to allow the vehicle to be operated in a variety of conditions with the same mass weight. While effective for general OEM use, such a design is not desirable in applications where maximum power output is demanded because specific power output is sacrificed in lieu of greater operating range. In effect, while it is universally acknowledged that cam profile is as important a factor in the dynamic function of flyweight design as mass weight, there is no allowance for adjustment of the cam profile except during the design phase of the manufacture of these flyweights.

Adjustable flyweights as are employed in CVT's conventionally have removable mass-adding weights that can be added to or subtracted from the flyweights to achieve total mass changes. These weights are held at fixed points in a parallel position relative to the rotational axis of the flyweight along the cam section and are non-movable during operation. They may be in a form of screw, pin, rivet or formed slug composed of various materials to achieve differing mass. While effective at allowing for variations in total mass and placement of such mass, no adjustment or variation can be made to the cam profile of the weights, which greatly diminishes the ability to adjust the shift parameters. Also, due to the confusing and complex nature of small parts, these styles of adjustable flyweights are undesirable for general use and are considered more as a tuning aid.

One attempt at improving adjustable flyweight design is illustrated by Peterson in U.S. Pat. No. 5,562,555, in which there are employed removable weights that are adjustable in position relative to the rotational axis. These removable weights allow for more specific tuning of mass location along the cam section of the flyweight and are considered an improvement of the conventional design. However, absent is the ability to adjust the cam profile.

Another attempt is illustrated by Hooper in U.S. Pat. No. 5,795,255, in which is disclosed an internal longitudinal cavity located in the centrifugal mass region of the cam arm and having a cavity opening located in the proximal end of the centrifugal mass region; and a means for adding mass to said internal cavity. Preferably, this cavity is in the form of a threaded hole that accepts threaded fasteners which can be inserted into the desired location by the user/tuner to adjust mass location. Still, there is no ready means taught by Hooper for altering the cam profile.

Thus, it has therefore become apparent that an adjustable flyweight is needed that accomplishes the goals of providing both adjustable mass and cam profile respectively, a flyweight that is near-monolithic in design and simple to adjust in place on the vehicle. The present invention is relative to adjustable flyweights which commonly employ adjustable means to affect overall mass and specific mass placement in relation to the rotatable axis of adjustable flyweights. More specifically, the present invention relates to flyweights which have adjustable cam profile through pitch adjustment, said pitch being relative to the linear profile of the flyweight cam section.

### SUMMARY OF THE INVENTION

Accordingly, it is the primary object of the present invention to provide a flyweight for continuously variable transmissions that has a field-adjustable cam profile.

It is another object of the present invention to provide ease of peak RPM adjustments of a CVT equipped vehicle without the need for disassembly.

It is yet another object of the present invention to provide an adjustable flyweight that requires no loose parts to complete adjustment and is nearly monolithic in design.

It is also an object of the present invention to provide an adjustable flyweight which has an automatic RPM-limiting feature in the form of an elastic compression element integral with the cam profile adjustment screw.

Finally, it is the object of the present invention to provide the operator of a CVT equipped vehicle with an infinitely adjustable flyweight that is applicable to conventional CVT's without modification.

An apparatus is disclosed for aiding in adjustments to the peak RPM and shift-ratio characteristics of a CVT equipped vehicle. The apparatus comprises two interconnected halves of a conventional flyweight design permanently conjoined by an encapsulated knuckle-style pivot joint which serves as the axis of adjustment of the pitch of the cam profile of this particular design. Included in the design is a threaded adjustment screw which serves as a position setting device that cantilevers against one side of the particular pivotal axis. Through the pushing and holding action of this threaded fastener, adjustment of the cam profile angle is accomplished and held in check during operation. Additionally, there are employed threaded receptacles on the cam section which will accept various removable weighted screws to provide additional adjustment of total mass.

Accordingly, in the illustrated embodiment of the present invention, the adjustable flyweights are constructed of heat-treated high-strength steel or other material of sufficient quality so as to withstand continued use. The overall dimensions of the present invention are such so as to be a direct replacement for a conventional flyweight without modification to the drive clutch.

Adjustment of the present invention is accomplished with the use of a suitable driving device of such dimensions to adequately rotate the main adjustment screw (such as a t-handle hex wrench or screwdriver). Preferably, the same driver used in adjusting the main cam profile will also serve to add or remove the additional threaded weights in the cam section of the flyweight.

### BRIEF DESCRIPTION OF THE DRAWINGS

The accompanying drawings illustrate several aspects of embodiments of the present invention. The drawings are for the purpose only of illustration preferred modes of the invention and are not to be construed as limiting the invention.

FIG. 1 is a partially exploded view of the prior art in a primary clutch showing a typical cam-profile of a CVT flyweight.

FIG. 2 is a magnified view of the prior art showing removable mass-adding weights.

FIG. 3 is a schematic exploded view of the present invention.

FIG. 4 is a side view of the invention showing rotational adjustment of the cam-section and means for cam-profile pitch changes.

FIG. 5 is a cut away view of the present invention to illustrate its application and function on a drive clutch of a CVT.

FIG. 6 is an enlarged cutaway-view of the cam-profile pitch-adjustment mechanism of the present invention.

FIG. 7 is an enlarged cutaway-view of the cam-profile pitch-adjustment mechanism integral with a compressible elastic element to facilitate partially-automatic peak-RPM adjustment means.

### DETAILED DESCRIPTION OF THE PREFERRED EMBODIMENTS

The present invention is intended to be applied in direct replacement of an existing component of the prior art. Specifically, the present invention is designed to replace the conventional flyweight of a CVT equipped vehicle.

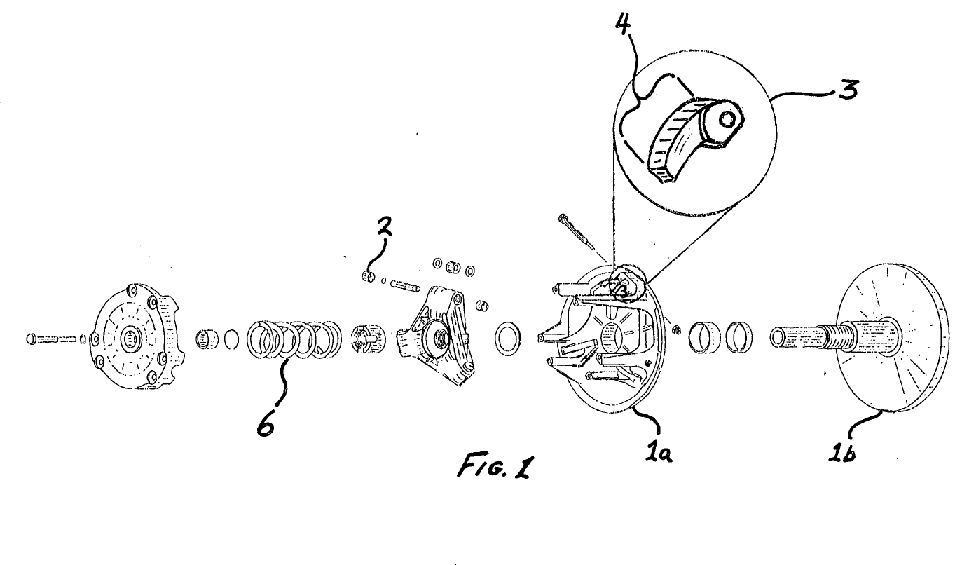

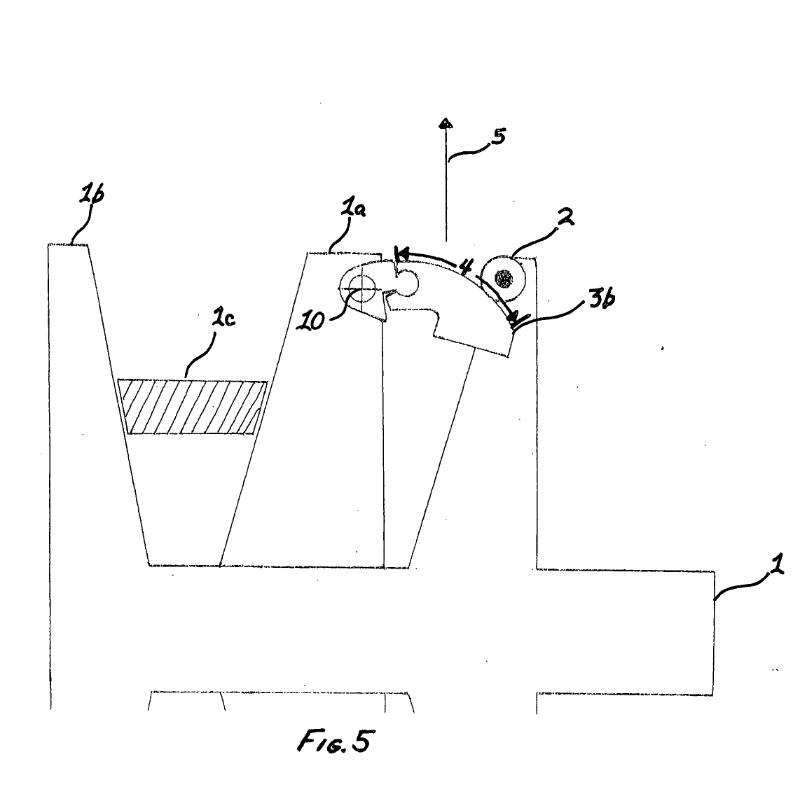

A variable speed belt drive, or CVT, is shown in FIGS. 1 and 5. When rotation is induced by the drive engine, drive clutch 1 employing moveable sheave 1a and fixed sheave 1b; fixed sheave 1b having interconnected cam-following roller 2 is laterally acted upon by flyweight 3. When conventional flyweight 3 rotates due to centrifugal force 5 induced by rotation of the drive engine, cam surface 4 forces upon cam following roller 2, forcing moveable sheave 1a to move towards fixed sheave 1b and begin to frictionally engage endless belt 1c. The sum force exerted upon movable sheave 1a and endless belt 1c by conventional flyweight 3 is dependent upon the total mass of flyweight 3 and cam surface 4 contacting angle upon cam-following roller 2 minus the retaining force of engagement spring 6 which acts against moveable sheave 1a to retain drive clutch 1 in a neutral gear.

As conventional flyweight 3 rotates upon acceleration of the drive engine, the shift ratio of drive clutch 1 is dependent upon the correlation of distance between moveable sheave 1a and fixed sheave 1b, and the radial circumference of actively engaged cam surface 4 relative to cam-following roller 2. Without respect to the total mass of conventional flyweight 3, a smaller radius of cam surface 4 causes drive clutch 1 to shift out with more force on endless belt is than a larger radius on cam surface 4 of conventional flyweight 3. Correspondingly, adjusting the pitch of cam surface 4 away from cam following roller 2 would effectively change the contacting angle in much the same way.

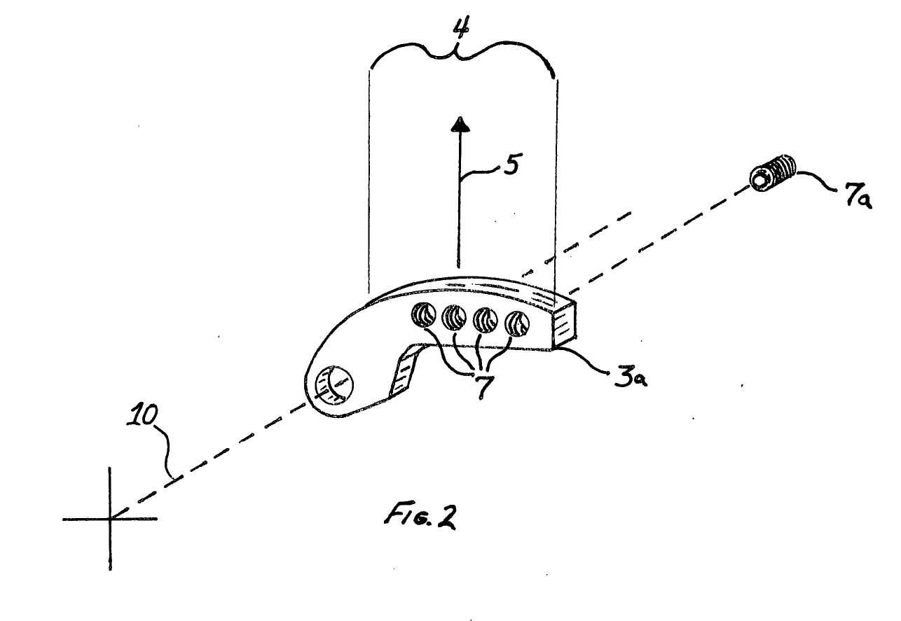

In FIG. 2, conventional adjustable flyweight 3a is shown having receptacles 7 for removable mass-adding weights 7a. Mass adding weights 7a are pressed in, riveted, molten, or threaded into receptacles 7 to add mass to conventional adjustable flyweight 3a.

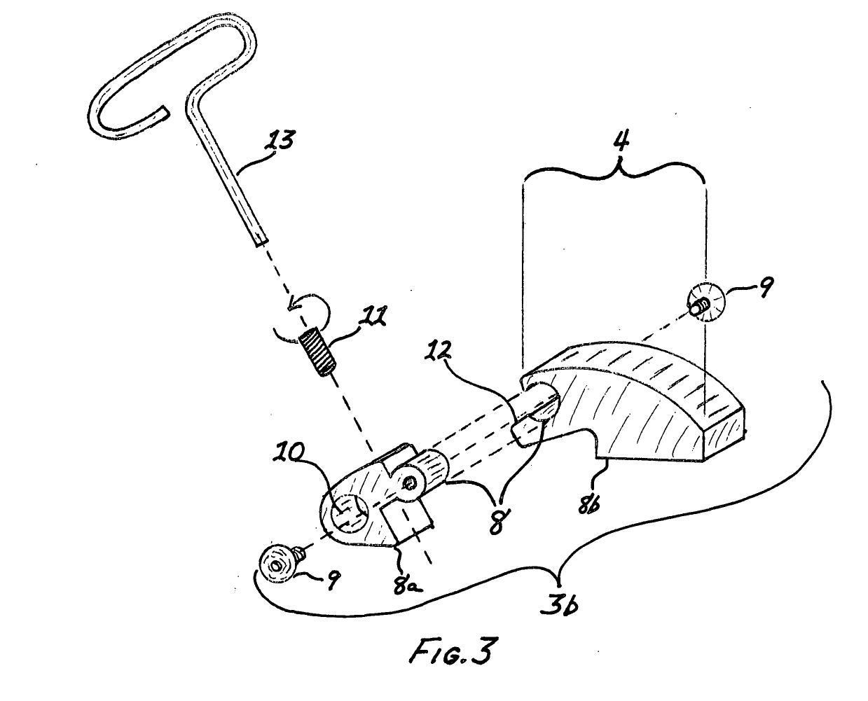

In FIG. 3 is shown the present invention. Illustrated is pitch-adjustment pivot 8 of present invention 3b. Side-load retaining fasteners 9 act to retain the alignment of flyweight halves 8a and 8b during use and to allow access for disassembly. Flyweight half 8a houses centrifugal pivot axis 10 and pitch adjustment mechanism 11. Flyweight half 8b houses cantilever thumb 12 which is acted upon by pitch adjustment mechanism 11 to retain pitch adjustment of cam surface 4 at a desired contact angle; adjustment wrench 13 is used to enable rotation of pitch adjustment mechanism 11 to accomplish this effect.

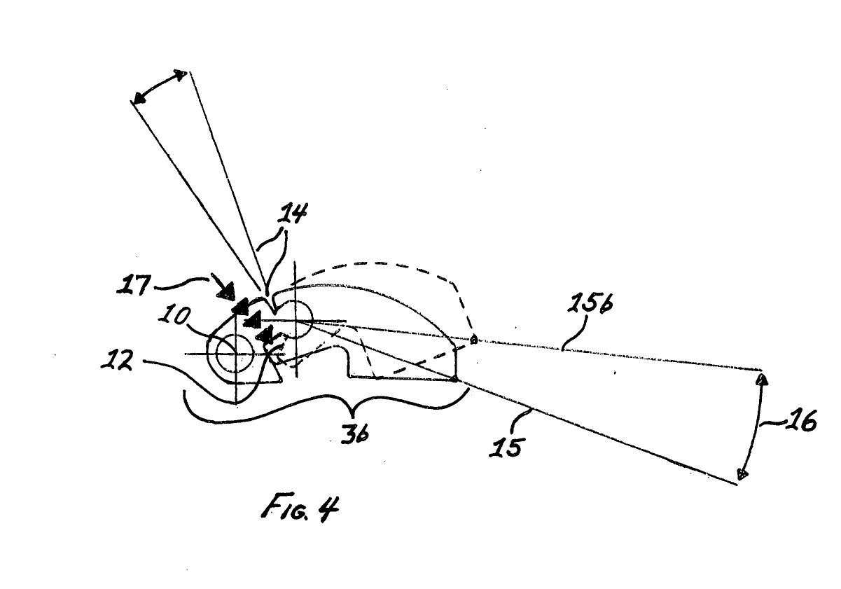

In the illustrated embodiment of present invention 3b shown in FIG. 4, relief 14 allows for unimpinged adjustment of present invention 3b in infinite degrees of angle between relaxed position 15 and fully extended position 15b. This range of adjustment is defined by but is not limited to angle indicator 16. The direction of the retaining force of pitch adjustment mechanism 11 acting on cantilever thumb 12 is shown in force line 17.

Centrifugal force 5 is shown in FIG. 5 to indicate the rotational effect of drive clutch 1 on present invention 3b. Cam surface 4 has a shallow contact angle at fully extended position 15b and in effect simulates a large radius.

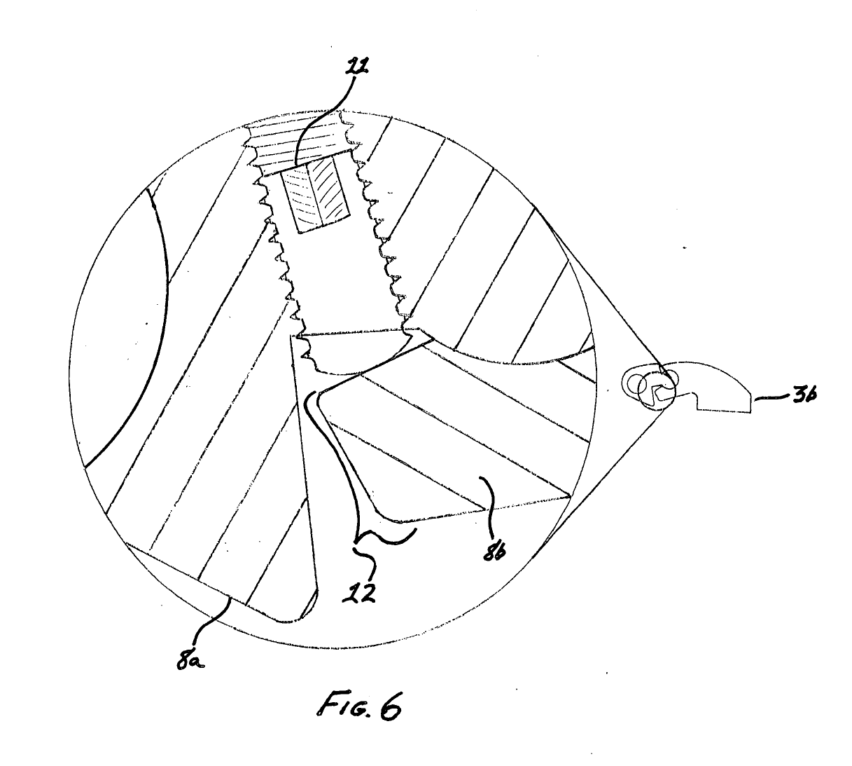

In the magnified view (as shown in FIG. 6) of present invention 3b, pitch adjustment mechanism 11 is illustrated with the preferred embodiment of pitch adjustment mechanism 11 in the form of a set screw. Lateral location of pitch adjustment mechanism 11 is fixed during operation.

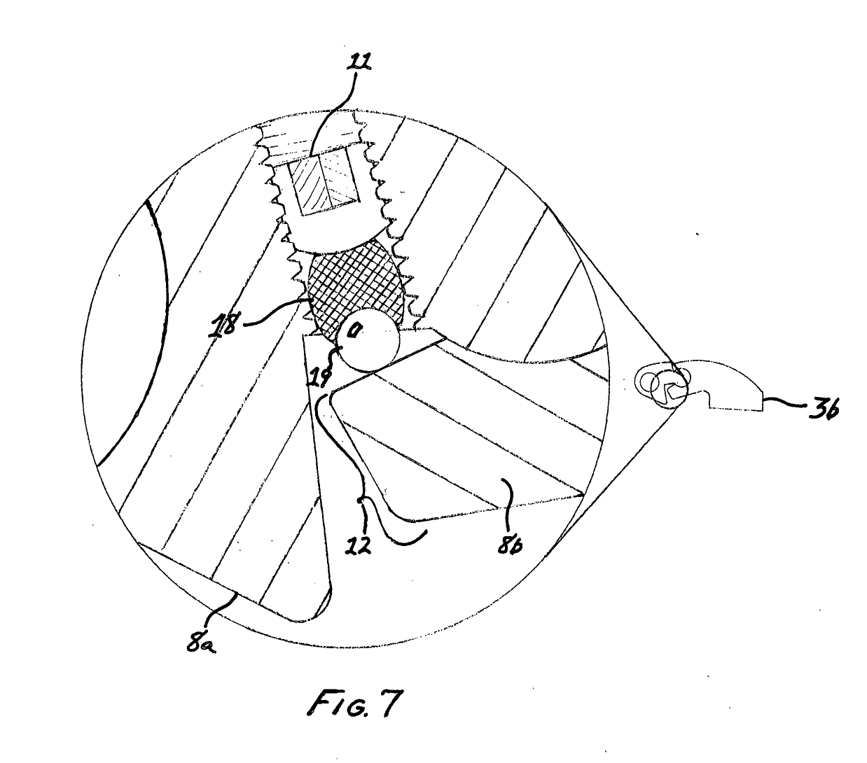

In the magnified view (as shown in FIG. 7) of present invention 3b, pitch adjustment mechanism 11 is illustrated having compressible elastic element 18 integral showing pitch adjustment mechanism 11 as a set screw. Compressible elastic element allows flyweight half 8b to move away from cam following roller when centrifugal force 5 overcomes the preset compression resistance of compressible elastic element 18. This acts to increase the shift ratio of drive clutch 1 and increase load on the engine, thus controlling maximum engine RPM's. Hardened steel sphere 19 retains compressible elastic element 18 in place.

Although this invention has been described above with reference to particular means and embodiments, it is to be understood that the present invention is not limited to these disclosed particulars, but extends to all equivalents within the broad scope of this Description, including the drawings.

I claim:

1. A flyweight for a driven clutch of belt-driven continuously variable transmission (CVT) having a main body containing a primary axis, and a cam-action section which shares a pivotal means with said main body; said pivotal means providing ability for bi-directional lateral deflection of said main body versus said cam-action section of said flyweight.

2. A flyweight as in claim 1, in which said bi-directional lateral deflecting means utilizing a flexible section or elastic member so constructed to simulate or effect said pivotal means.

3. A cam-style flyweight for a driven clutch of a belt-driven CVT apparatus comprising two sections; a first section which houses a primary axis, said primary axis being that from which said flyweight in its entirety is pivoted due to centrifugal force during operation, and a second section which houses a secondary axis, said secondary axis enabling bi-directional pivoting means of said first half in relation to said second section, said bi-directional pivoting means acting in the same plane as said primary axis.

4. A cam-style flyweight for a driven clutch of a belt-driven CVT apparatus having a primary axis and a means for eccentric profile pitch-adjustment, said pitch-adjustment means being pivotal on the same axial-plane as said primary axis.

5. A cam-style flyweight as in claim 4 having a bi-directional adjustment of said eccentric profile pitch angle with a range between one (1) and fifteen (15) degrees in both directions.

6. A cam-style flyweight for a driven clutch of a belt-driven CVT apparatus having a replaceable cam surface.

7. A cam-style flyweight for a driven clutch of a belt-driven CVT apparatus having a cam surface which is alterable in its operational position.

8. A cam-style flyweight for a driven clutch of a belt-driven CVT apparatus being made from or partially constructed of such material so constructed as to own an elastic property more flexible than that of metal.

9. A cam-style flyweight for a driven clutch of a belt-driven CVT apparatus having a flexible cam surface.

10. A flyweight for a belt driven continuously variable transmission, or CVT, which has a cam section, said cam section having a deflectable means, said cam section with said deflectable means being held in a desired position restrained from movement by elastically-resistive means, said cam section held in said position in such a way by said resistive means so as to resist deflection until a specific RPM of the drive engine thus connected to said CVT is reached, said specific RPM initiating a preset centrifugal force, at which point said cam section deflects away from a load.

11. A flyweight as in claim 10 wherein said deflectable means of said cam section of said flyweight acts to automatically resist over-revving of said CVT.

12. A flyweight for a continuously variable transmission having an adjustable cam-section pitch-angle that employs removable mass-adding weight or weights to enable variance of total mass of said flyweight. Said removable weights may be in the form of a screw, pin, rivet, or molten material.
